(19) United States
(12) Patent Application Publication
(10) Pub. No.: US 2019/0033258 A1
(43) Pub. Date: Jan. 31, 2019

(54) EXCITATION AND SENSING SYSTEMS AND METHODS FOR DETECTING CORROSION UNDER INSULATION

(71) Applicant: QUEST INTEGRATED, LLC, Kent, WA (US)

(72) Inventors: Phillip Dewayne BONDURANT, Covington, WA (US); Anthony MACTUTIS, Auburn, WA (US); Arvid HUNZE, Lower Hutt (NZ); Joseph BAILEY, Wellington (NZ)

(73) Assignee: QUEST INTEGRATED, LLC, Kent, WA (US)

(21) Appl. No.: 16/071,892

(22) PCT Filed: Jan. 23, 2017
(86) PCT No.: PCT/US2017/014608

§ 371 Date: Jul. 20, 2018

Related U.S. Application Data
(60) Provisional application No. 62/281,633, filed on Jan. 21, 2016.

(51) Int. Cl. G01N 27/83

(52) U.S. Cl. CPC G01N 27/83

(57) ABSTRACT

Systems and methods for detecting corrosion under insulation are disclosed herein. In one embodiment, an apparatus for detecting corrosion in an object includes an electrically conductive excitation unit disposed around the object, and a source of electrical power connected to the excitation unit. The source of electrical power causes an alternating current in the excitation unit. The apparatus also includes a carrier that carries the excitation unit, and a magnetic sensor unit that is carried by the carrier or by the excitation unit. The sensor detects changes in magnetic flux.

### CROSS-REFERENCE TO RELATED APPLICATION

This application claims the benefit of U.S. Provisional Application No. 62/281,633, filed Jan. 21, 2016, the contents of which are incorporated herein by reference in their entirety.

### BACKGROUND

Corrosion under insulation (CUI) is a known problem in the energy industry. Such corrosion typically develops as the rainfall water, atmospheric moisture, or steam condenses under the insulation of the piping or vessels. Existing methods of detecting corrosion under insulation (CUI) include radiographic, guided waves, pulsed eddy current, and standard eddy current. However, the existing methods have shortcomings.

For example, radiographic methods require a source of radiation to be positioned opposite the radiation sensor. This requires space on both sides of the pipe. In addition, radiographic methods also present a hazard to the operators.

Guided wave methods require removal of the insulation and metallic cover to gain access to the pipe to install the guided wave ultrasonic transducers. The ultrasonic transducers are arranged in a ring to produce ultrasonic signals axially down the pipe under the insulation. In operation, defects cause reflections of the ultrasonic waves that can be detected by the ring of signal receiving transducers. However, removal of the insulation is generally an undesirable step. Additionally, the guided waves often do not propagate far enough under the insulation to reach the corrosion patch, and the axial propagation distance is not predictable. Another shortcoming of the guided wave methods is that these methods do not measure wall thickness. For example, while the method may measure overall cross sectional area loss, it is difficult to assess the shape or the exact location of the corrosion patch that causes wall cross-section loss. General information on guided waves is provided in Lowe, M. J. S. and Cawley, P., “Long Range Guided Wave Inspection Usage—Current Commercial Capabilities and Research Directions,” Department of Mechanical Engineering, Imperial College London, Mar. 29, 2006.

Pulsed eddy current (PEC) can also be used for the CUI detection. With the PEC methods, a coil is driven with an electrical pulse to cause an eddy current in the pipe. The resulting eddy current signal diffuses and decays through the wall thickness. The decay characteristics of the signal are then used to derive the wall thickness. With this method the pipe insulation does not need to be removed. However, the method produces a spot measurement using a large coil that must be held rigid at a single location for several seconds, which makes it difficult to obtain reliable readings in practical implementation. The PEC approach is described in U.S. Pat. Nos. 6,291,992; 6,570,379; 6,037,768; 4,843,320; and 4,843,319. One shortcoming of the PEC method is that even with an automated scanner that rotates the coil circumferentially around the pipe at a fixed axial location, the measurement must be repeated for each axial location along the segment of the pipe to be evaluated. Therefore, the measurement is slow and difficult to implement in the tight spacing between adjacent parallel pipes.

In some methods, arrays of pulsed eddy current sensors are used along the pipe. However, the relatively close proximity of multiple transmitters can cause significant signal interference between the receiving sensors.

Other eddy current methods have been proposed and used, such as the meandering wire magnetometer (MWM). The MWM method sets up a spatially-varying excitation field with interspersed receive sensors. Based on the sensors signal, the magnetic permeability or electrical conductivity of the surface can be back-calculated through an inversion process. Next, the wall thickness can be derived from the magnetic permeability and/or electrical conductivity of the pipe segment. However, with this approach the excitation/sensing wires again need to be mechanically scanned around the circumference of the pipe, similarly as with the PEC methods. The MWM based approaches are described in U.S. Pat. Nos. 5,015,951; 5,793,206; 6,144,206; and 6,188,218. More information about MWM method is also available at www.jenteksensors.com.

Accordingly, there remains a need for cost effective and efficient detection of corrosion patches on the insulated pipes and vessels.

### DESCRIPTION OF THE DRAWINGS

The aspects of the present disclosure can be better understood with reference to the following drawings. The components in the drawings are not necessarily to scale. Instead, emphasis is placed on clearly illustrating the principles of the present disclosure.

FIG. 1 is a cross-sectional view of insulated pipe in accordance with prior art.

FIG. 2 is a partially schematic, isometric view of meandering wire used for detecting corrosion under insulation in accordance with prior art.

FIG. 3 is an isometric view of a system for detecting corrosion in accordance with an embodiment of the presently disclosed technology.

FIG. 3A is a cross-sectional view of a system for detecting corrosion in accordance with an embodiment of the presently disclosed technology.

FIGS. 4A and 4B are partially schematic, axial views of systems for detecting corrosion in accordance with an embodiment of the presently disclosed technology.

FIG. 5 is a partial cross-sectional view of a system for detecting corrosion in accordance with an embodiment of the presently disclosed technology.

FIGS. 6A and 6B are partially schematic, isometric views of magnetic flux sensors in accordance with an embodiment of the presently disclosed technology.

FIG. 7 is a graph of sensor signal as a function of sensor location in accordance with an embodiment of the present technology.

FIG. 8 is a graph of maximum sensor signal as a function of excitation frequency in accordance with an embodiment of the present technology.

FIG. 9A is a schematic view of tilted excitation unit with reference to pipe cover in accordance with an embodiment of the present technology.

FIG. 9B is a graph of sensor signal as a function of distance between sensor and excitation unit for tilted excitation unit in accordance with an embodiment of the present technology.

FIG. 9C is a schematic view of excitation unit that is non-concentric with reference to pipe cover in accordance with an embodiment of the present technology.

FIG. 9D is a graph of sensor signal as a function of distance between sensor and excitation unit for the excitation unit that is non-concentric with reference to pipe in accordance with an embodiment of the present technology.

FIG. 10 is a graph of sensor signal as a function of distance between sensor and excitation unit in accordance with an embodiment of the present technology.

### DETAILED DESCRIPTION

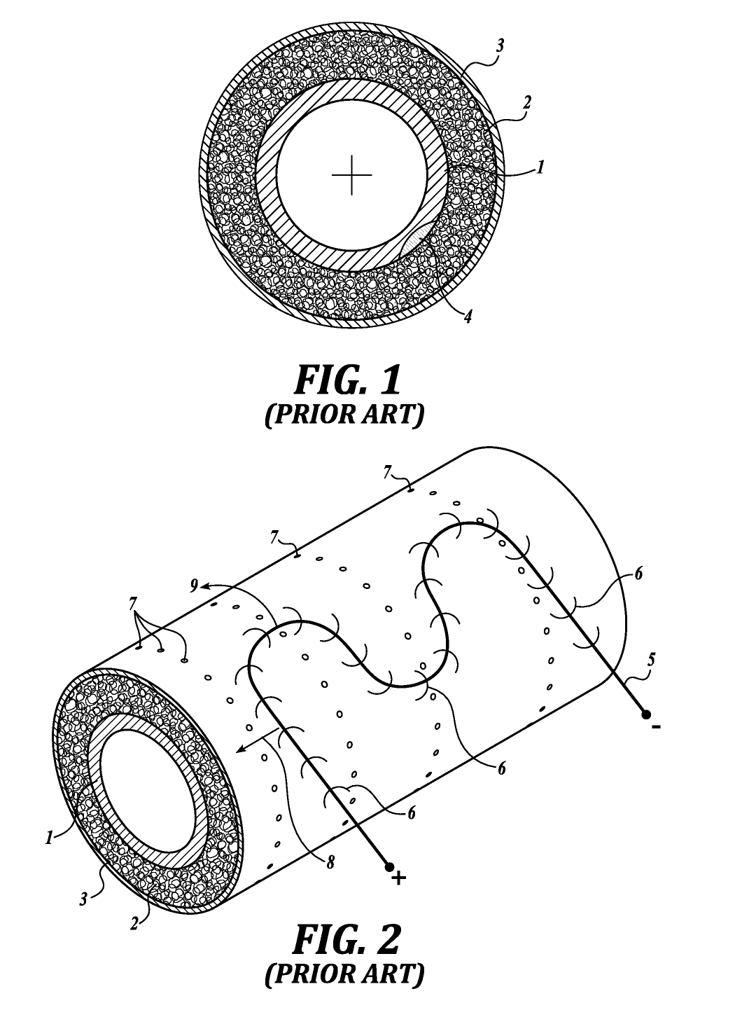

Specific details of several embodiments of representative systems and methods for detecting corrosion under insulation are described below. The systems and methods can be used for detecting corrosion on, for example, piping, tanks or vessels. A person skilled in the relevant art will also understand that the technology may have additional embodiments, and that the technology may be practiced without several of the details of the embodiments described below with reference to FIGS. 1-10.

Briefly described, systems and methods for detecting corrosion under insulation are described. The disclosed systems can detect corrosion patches on the pipe in the presence of the metallic cover, can easily be transported axially along the pipe while collecting data, and can operate in presence of adjacent parallel pipe structures. In some embodiments, an excitation unit (e.g., one or more metal conductors) and a circular array of magnetic sensors surrounds the pipe, insulation, and weather shield. The excitation unit conducts alternating current that, in turn, causes magnetic field in the material of pipe. The magnetic field in the pipe causes a corresponding current in the pipe. When a corrosion patch is in the path of the current in the pipe, the effective cross section of the material of the pipe that is available for the flow of electrical current is reduced. As a result, the current around the corrosion patch is rerouted, generating an additional magnetic field that is detected by the magnetic sensors, therefore indicating a presence of the corrosion patch on the pipe. Additionally, magnetic permeability of the corrosion patch is also lower than that of the surrounding pipe material, thus also causing changes in the magnetic flux in the vicinity of the corrosion patch.

In some embodiments, the alternating current in the excitation unit can be generated by a transformer (also referred to as a transformer coil). In some embodiments, frequencies of the alternating current in the excitation unit can be selected to maximize sensitivity of the magnetic sensors to the corrosion patch and/or to minimize sensitivity of the magnetic sensors to naturally-present variations in magnetic permeability of the pipe material.

FIG. 1 is a cross-sectional view of insulated pipe in accordance with prior art. Illustrated pipe 1 is surrounded by insulation 2 and a weather shield 3. In practice, the thickness of the weather shield 3 may be an order of magnitude smaller than that of the pipe 1. In many instances, the pipe 1 is made of steel. The weather shield 3 can also be made of electrically conductive metals, for example aluminum. As used herein, the term “electrically conductive materials” refers to materials with electrical conductivity greater than about 1 Siemens per meter (S/m). In some embodiments, the electrically conductive materials (e.g., the pipe 1 and/or weather shield 3) have electrical conductivity greater than about 1×10⁶ S/m. In many cases, electrical conductivity and magnetic permeability of a corrosion patch 4 is significantly lower than that of the pipe 1.

FIG. 2 is a partially schematic, isometric view of meandering wire used for detecting corrosion under insulation in accordance with prior art. In operation, a serpentine wire 5 conducts an alternating current that, in turn, causes eddy currents in the pipe 1 and the weather shield 3. The eddy currents are detected and measured by interspersed sensors 7. The detected eddy currents are, at least in part, function of the magnetic permeability and/or electrical conductivity of the surface. Therefore, the wall thickness can be back calculated from the magnetic permeability and/or electrical conductivity of the pipe segment. However, the measurement is localized to a particular spot on the pipe, both axially and circumferentially. Therefore, multiple measurements are required for mapping, for example, a segment of a pipe.

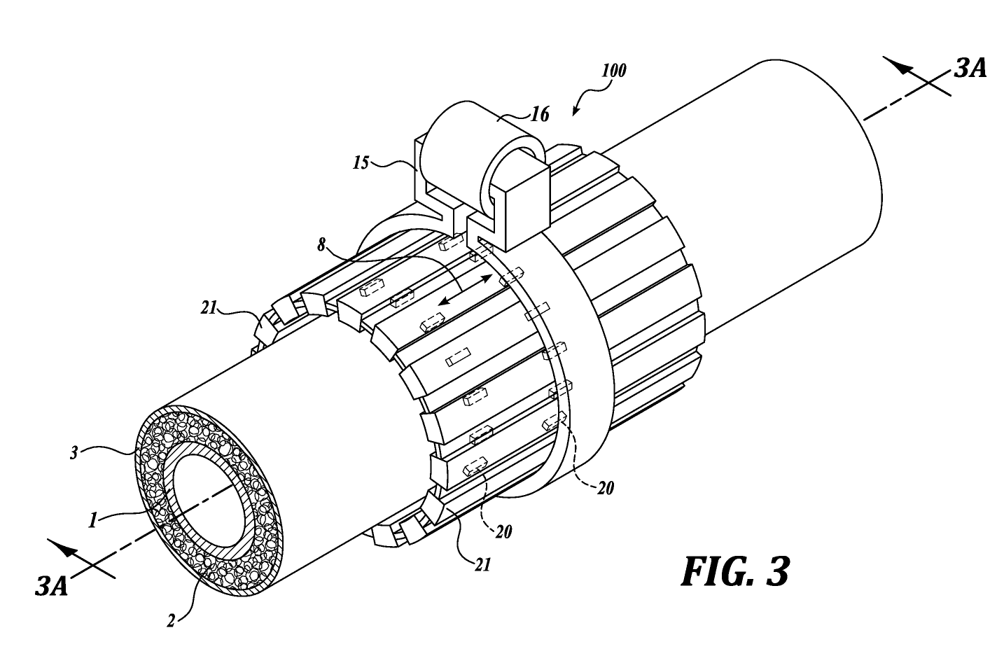

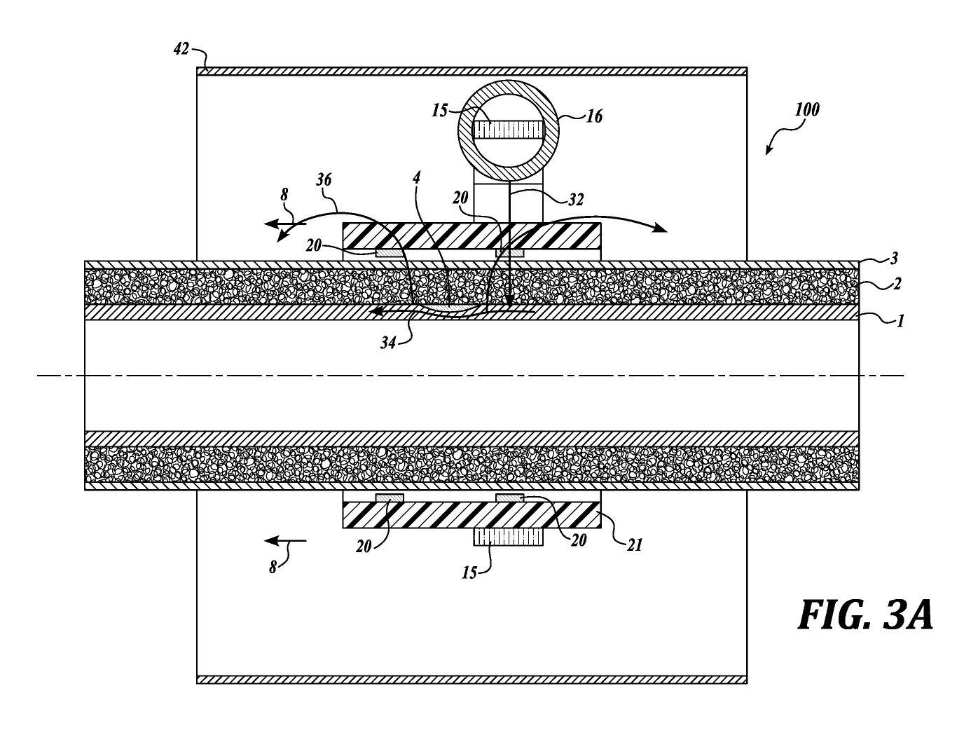

FIG. 3 is an isometric view of a system 100 for detecting corrosion in accordance with an embodiment of the presently disclosed technology. The system 100 includes an excitation unit 15 (e.g., metal conductor, wire, a bundle of wires, etc.). The excitation unit 15 can run around essentially entire circumference of the weather shield 3. The illustrated excitation unit 15 has a monolithic conductor, but in some embodiments the excitation unit 15 can include multiple conductors that run in parallel mechanically and are mutually isolated electrically. In some embodiments, the excitation unit is made of copper. In some embodiments, the width of the excitation unit in the axial direction is in the 10-100 mm range.

In some embodiments, the alternating current in the excitation unit 15 is generated by a transformer 16 via electromagnetic (EM) coupling of the transformer 16 (also referred to as a transformer coil) and the excitation unit 15. For example, the transformer coil 16 may serve as a primary coil, and the excitation unit may serve as a secondary coil. In some embodiments, it is advantageous to maximize the current in the excitation unit by, for example, increasing the number of turns in the transformer 16, and decreasing the number of turns in the excitation unit 15, which may have just one turn.

In some embodiments, carriers 21 are arranged around the weather shield to provide structural support for the excitation unit 15, and to carry magnetic sensor units 20. In some embodiments, the carriers 21 may be made of dielectric materials, for example plastics, that minimize interference with electromagnetic field. In operation, the carriers 21 can be moved along or about the weather shield 3 as indicated by arrow 8 to improve detection of the corrosion patch. The illustrated carriers 21 are between the excitation unit 15 and the weather shield 3. However, in some embodiments the carriers 21 can be on the outer side of the excitation unit 15, or wrapped around the excitation unit 15.

In some embodiments, the magnetic sensor units 20 are arranged in arrays along the perimeter of the weather shield. For example, the magnetic sensor units 20 can be arranged in two arrays: one generally under or close to the excitation unit, and the other array axially offset from the first one. In some embodiments, the individual magnetic sensor units of the array can be arranged at fixed polar angle, for example an array of magnetic sensor units 20 can be arranged at about 5 degree, under 10 degree, or about 10 degree sensor-to-sensor distance in the polar direction. In some embodiments, the array of magnetic sensor units 20 can be partial in the polar direction, for example, the magnetic sensors not being present in the area under the transformer. In some embodiments, more than two arrays of the magnetic sensors can be used. In the illustrated embodiment, the magnetic sensors 20 are attached to the inner surface of the carriers 21 (between the carriers 21 and the weather shield 3), but other positions of the magnetic sensors 20 are also possible. For example, the magnetic sensors 20 can be attached to the outer surface of the carriers 21. In some embodiments, some or all magnetic sensors 20 can be attached to the excitation unit 15.

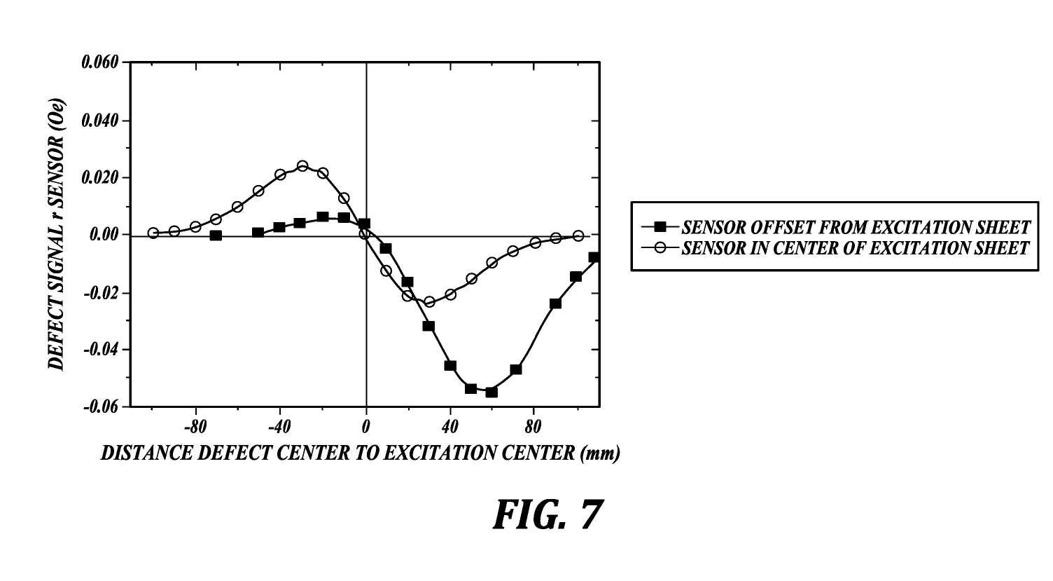

FIG. 3A is a cross-sectional view A-A of the system 100 for detecting corrosion in accordance with an embodiment of the presently disclosed technology. In operation, the current source 16 (e.g., a transformer coil) causes an alternating current to flow in the excitation unit 15. Without being bound by theory, it is believed that the alternating current in the excitation unit causes magnetic flux 32, which, in turn, causes a current 34 in the pipe 1. When the current 34 arrives to the corrosion patch 4, the current must accelerate because of the smaller cross-section of the pipe available to the current 34, and then decelerate as the available cross-section of the pipe increases pass the corrosion patch. The acceleration and deceleration of the current may cause magnetic flux 36, which is detected by the sensor unit 20. Some representative signals detected by the sensor unit 20 are described in FIGS. 7-10 below.

In some embodiments, the pipe cover 3 is made of a non-ferromagnetic material (e.g., aluminum), therefore having relatively small effect on the measured magnetic flux. Furthermore, the carriers 21 and the insulation 2 may also be non-ferromagnetic.

In some embodiments, the system 100 includes a flux concentrator 42. Without being bound by theory, it is believed that the flux concentrator may increase the signal-to-noise ratio (SNR) of the signal measured by the magnetic sensors 20, because the ferromagnetic material of the flux concentrator 42 limits the escape of the magnetic flux away from the magnetic sensor unit 20. The flux concentrator 42 may be between 40 and 250 mm wide in the axial direction, and preferably 200 mm wide. In some embodiments, the flux concentrator 42 may be positioned closer to the excitation unit 15 by, for example, making a hole in the flux concentrator for the current source 16 to protrude through. The flux concentrator 42 may be made of Permalloy or other high permeability material.

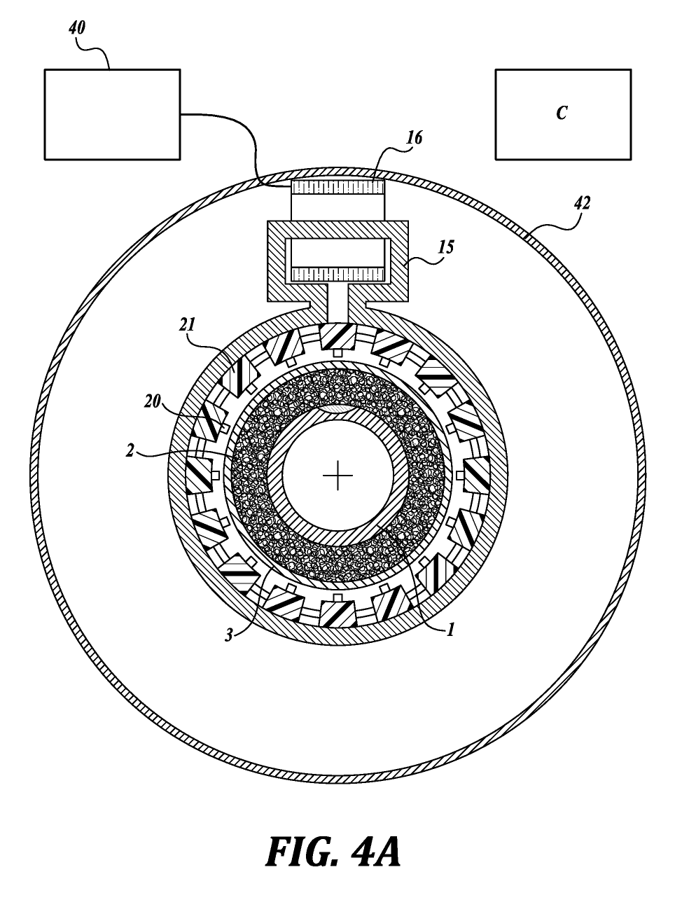

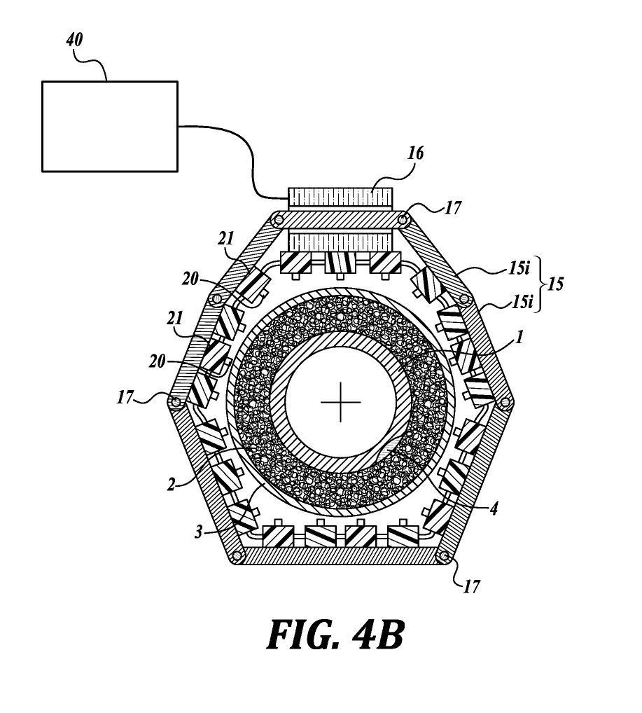

FIGS. 4A and 4B are partially schematic, axial views of systems for detecting corrosion in accordance with an embodiment of the presently disclosed technology. FIG. 4A illustrates a monolithic excitation unit 15, and FIG. 4B illustrates a segmented excitation unit 15.

FIG. 4A shows a signal source 40 connected to the current source 16. In some embodiments, the signal source 40 can be a power amplifier or audio amplifier operating in a frequency range of about 10 Hz to about 30 kHz. Without being bound to theory, it is believed that when the alternating current in the excitation unit is within the audible range of frequency, higher SNR for the magnetic flux may be recorded by the magnetic sensor unit 20. In some embodiments, the flux concentrator 42 may also improve the SNR for the magnetic sensor unit 20.

In some embodiments, a controller C collects and analyses measurement data of the magnetic sensor units 20. For example, the controller C may include software to identify the location of the corrosion patch 4. The controller C controls the operation of the signal source 40.

FIG. 4B shows segmented excitation unit 15. Illustrated segments 15i are straight, but curved segments 15i are also possible. The segments 15i may be interconnected by connectors 17 (e.g., screws, pins, rivets, etc.) In some embodiments, segmented excitation unit 15 is easier to mount-to or dismount-from the weather shield 3. Furthermore, in some embodiments a distance from the pipe 1 to the excitation unit 15 and/or the sensor units 20 can be controlled easier with the segmented excitation unit 15. Adjustability of the segmented excitation unit 15 may also be beneficial for testing the pipes that are closely spaced apart.

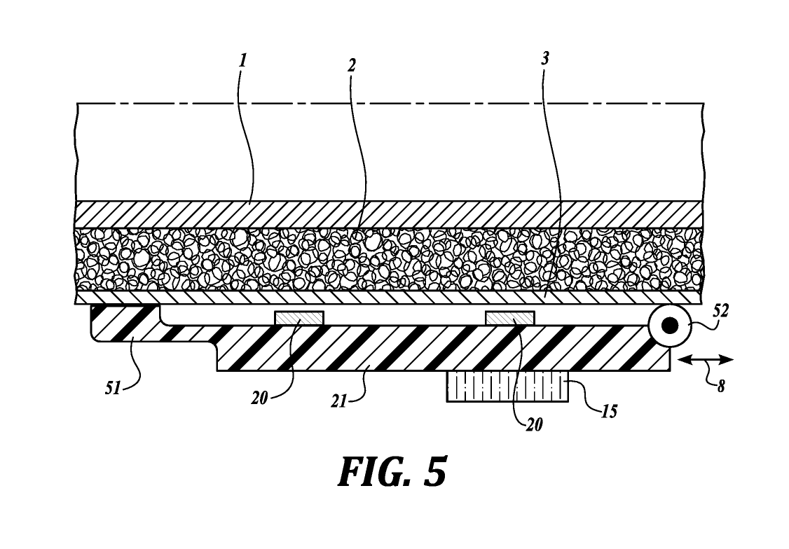

FIG. 5 is a partial cross-sectional view of a system for detecting corrosion in accordance with an embodiment of the presently disclosed technology. In some embodiments, one or more carriers 21 include sliders 51 and/or wheels 52 for improved transportability of the system along and about the weather shield 3. For example, with some measurement methods the system is moved in the axial direction while the magnetic sensor units 20 acquire data. Next, the system may be rotated, and moved axially in the opposite axial direction, resulting in a higher probability of the sensor unit 20 being proximate to the corrosion patch, which, in at least some embodiments, increases signal strength and/or SNR of the sensor unit 20.

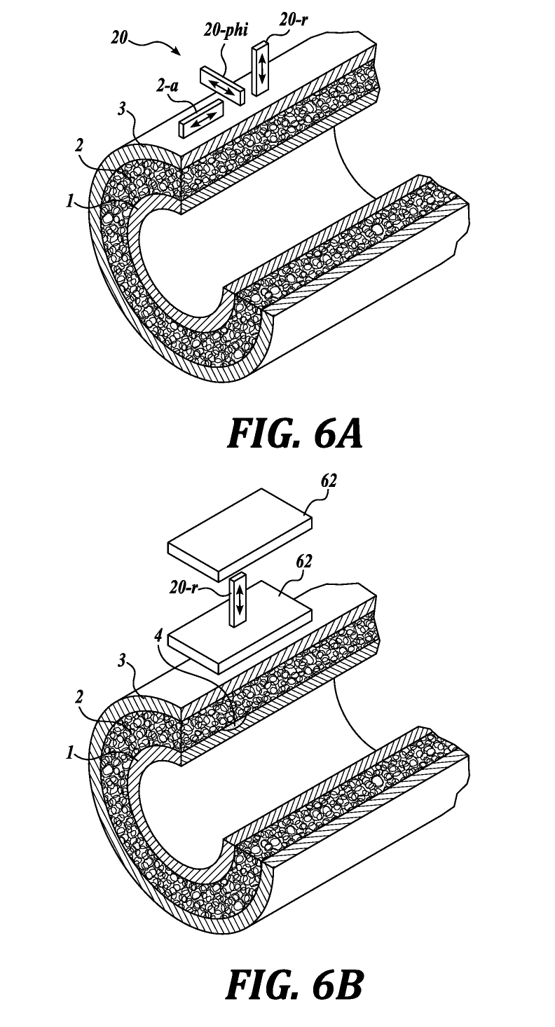

FIGS. 6A and 6B are partially schematic, isometric views of magnetic flux sensors in accordance with an embodiment of the presently disclosed technology. FIG. 6A illustrates an embodiment of the magnetic sensor unit 20 having three magnetic sensors, each primarily sensitive in a particular direction: sensors 2-a, 2-r, and 2-phi being primarily sensitive in the axial, radial, and polar directions, respectively. In some embodiments, the magnetic sensor unit 20 may include only one or two magnetic sensors. In some embodiments, magnetic sensors by NVE corporation can be used, for example, NVE's series AA or series AB magnetic sensors.

FIG. 6B illustrates the magnetic sensor 20-r between two flux diverter plates 62. In some embodiments, the flux diverter plates reduce the strength of the magnetic flux that reaches the magnetic sensor, thus preventing saturation of the magnetic sensor (e.g., preventing the exposure of the magnetic sensor to the magnetic flux that exceeds its sensitivity range). The flux diverter plates 62 may be made of Permalloy or other high permeability material.

FIG. 7 is a graph of sensor signal as a function of sensor location in accordance with an embodiment of the present technology. The horizontal axis shows distance from the center of the defect (e.g., a corrosion patch) to the center of the excitation unit (i.e., the width of the excitation unit) in mm. The vertical axis shows sensor signal in Oersted (Oe). Open circles correspond to the measurements taken by the sensors that are located in the middle of the excitation unit 15 (i.e., under or over the sheet). Solid squares correspond to the measurements taken by the sensors that are axially offset from the excitation unit 15. For both locations of the sensors, the measurements taken close to the middle of the corrosion patch and sufficiently far away from the corrosion patch are about 0 Oe. However, when the sensor is relatively close to the corrosion patch, but not at the middle of the corrosion patch, the sensor signal has a roughly sinusoidal shape as a function of distance from the middle of the corrosion patch. Furthermore, in some embodiments, the signal from the sensor located in the center of the excitation unit is more symmetrical than the corresponding signal form the axially-offset sensor. In at least some embodiments, the above-described signature of the sensor signals may be used to confirm the presence of the corrosion patch by, for example, a controller or a computer having suitable software.

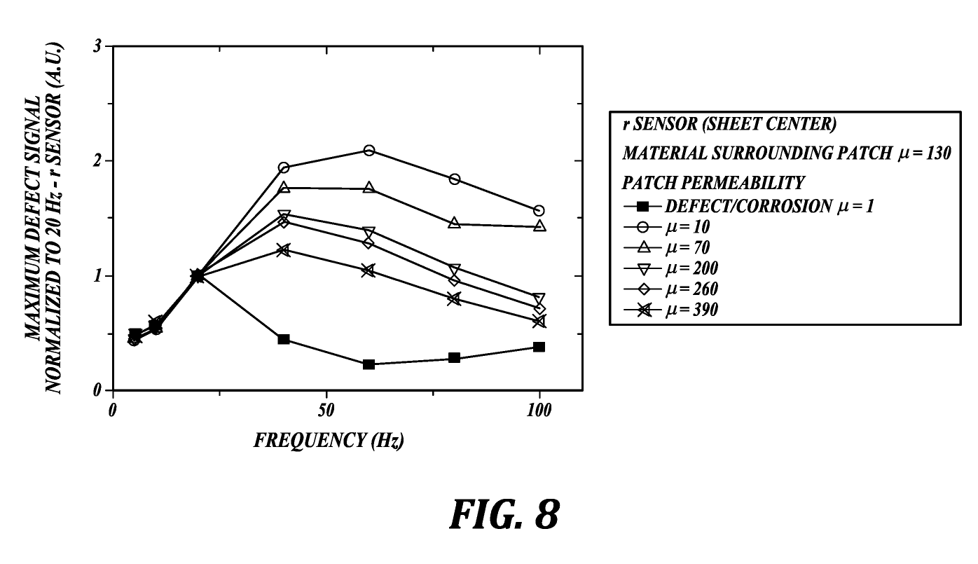

FIG. 8 is a graph of maximum sensor signal as a function of excitation frequency in accordance with an embodiment of the present technology. The horizontal axis shows different frequencies of the alternating current in the excitation unit 15. The vertical axis shows a normalized sensor signal. The corrosion patch generally has a permeability of about μ=1, whereas the surrounding metal may have significantly higher permeability, for example μ=10-390. Therefore, different frequencies of the alternating current in the excitation unit 15 and, consequently, the corresponding frequencies of the EM field will propagate differently through the pipe. In turn, the strength of the magnetic flux at the magnetic sensor unit 20 will also be different. For the illustrated embodiments, the corrosion patch causes the highest signal strength at about 10 Hz, whereas the non-corroded metal causes the highest signal strength at about 40 Hz and above. Therefore, in at least some embodiments, the signal strength and/or SNR may be improved by selecting an appropriate frequency for the detection of the corrosion patch, or by acquiring multiple measurements at different frequencies.

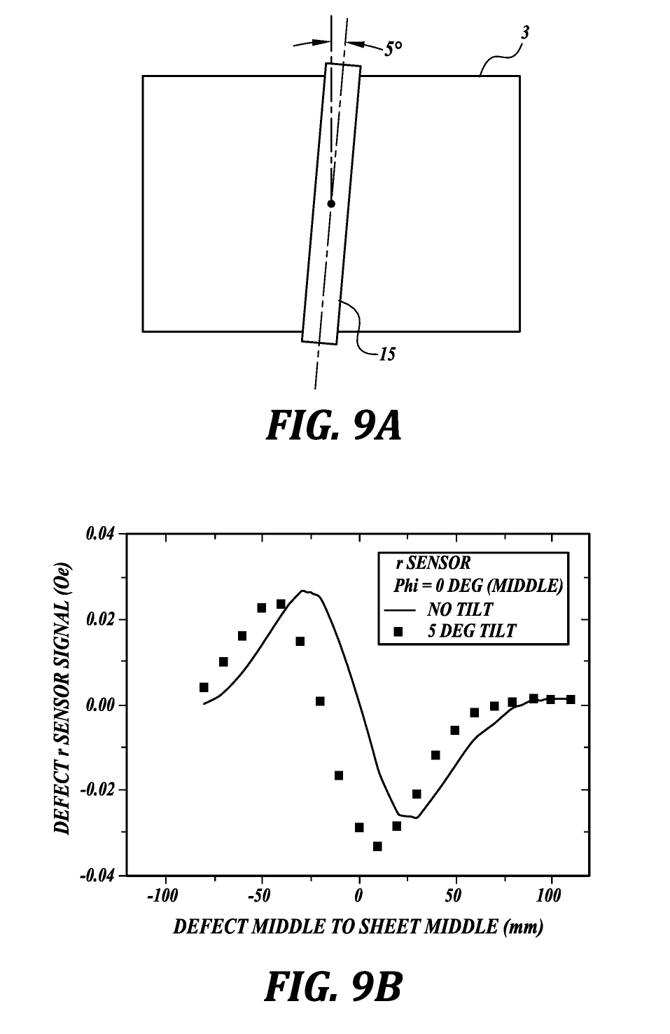

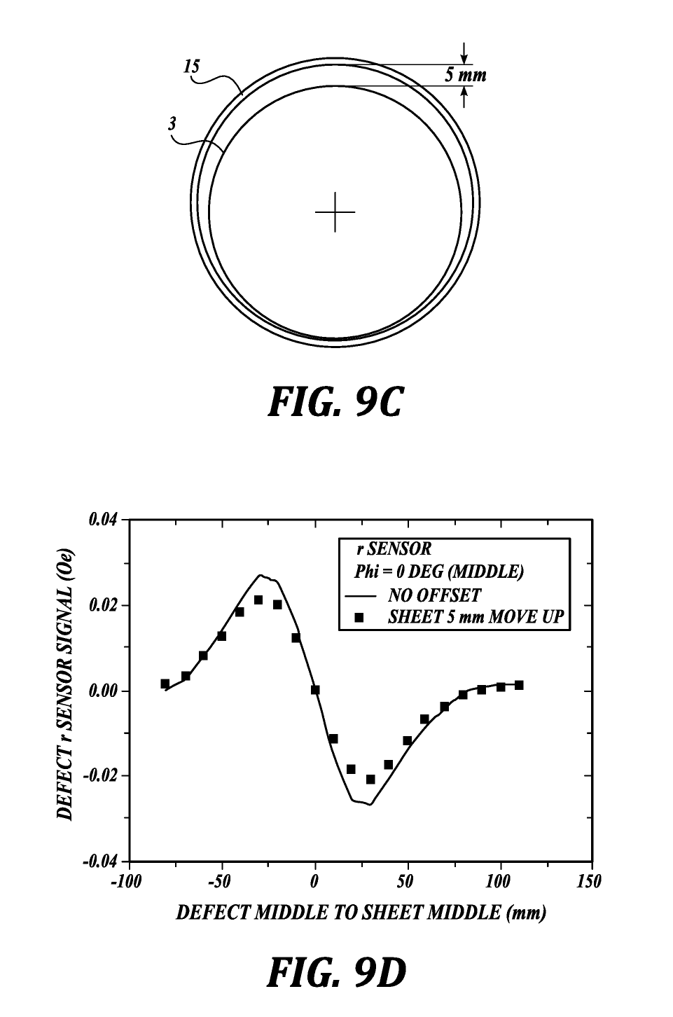

FIG. 9A is a schematic view of tilted excitation unit with reference to pipe cover in accordance with an embodiment of the present technology. In practical field measurements, the excitation unit may be tilted with respect to the weather shield 3 and the pipe 1 because of, for example, operator error. The embodiment illustrated in FIG. 9A shows a 5 degree tilt between the weather shield 3 and the excitation unit 15. However, in at least some embodiments, the inventive technology is robust enough to produce acceptable results even when the excitation unit 15 is tilted. Representative measurement results are discussed with reference to FIG. 9B below.

FIG. 9B is a graph of sensor signal as a function of distance between sensor and excitation unit for tilted excitation unit in accordance with an embodiment of the present technology. The horizontal axis shows distance from the defect (e.g., corrosion patch) to the excitation unit (excitation sheet). The vertical axis shows signal strength in Oe for the radial sensor. Two cases are shown: no tilt (solid line) and 5 degree tilt (solid squares). Even with the 5 degree tilt, the shape of the measurement curve remains similar to the no-tilt case. In at least some embodiments, the operator (or the controller or computer) can detect the presence of the corrosion patch based on the illustrated measurement curve.

FIG. 9C is a schematic view of excitation unit that is non-concentric with reference to pipe cover in accordance with an embodiment of the present technology. In this sample measurement, the excitation unit 15 is not concentric with respect to the weather shield 3 and the pipe 1. The lack of the concentricity is 5 mm, resulting in a non-uniform distance of the magnetic sensor units 20 from the pipe 1. However, the inventive technology still produces acceptable results, as discussed with reference to FIG. 9D below.

FIG. 9D is a graph of sensor signal as a function of distance between sensor and excitation unit for the excitation unit that is non-concentric with reference to pipe in accordance with an embodiment of the present technology. The horizontal axis shows distance from the defect (e.g., corrosion patch) to the excitation sheet (e.g., middle of the excitation unit 15). The vertical axis shows signal strength in Oe for the radial sensor. Two cases are shown: concentric or “no offset” (solid line) and 5 mm offset (solid squares). The change in the measurement values is relatively small for the two cases, indicating the robustness of the measurement method. As a result, the operator (or the controller or computer) can detect the presence of the corrosion patch even with the non-concentrically positioned excitation unit.

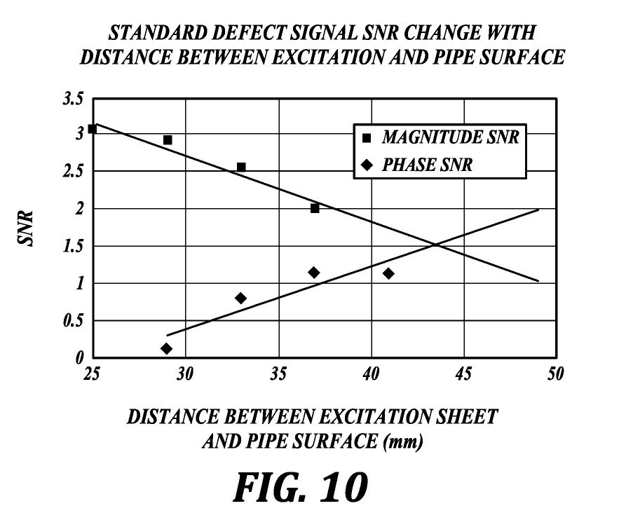

FIG. 10 is a graph of sensor signal as a function of distance between sensor and excitation unit in accordance with an embodiment of the present technology. The horizontal axis shows distance between the pipe surface and the excitation sheet (e.g., the excitation unit 15). The vertical axis shows SNR for the magnetic sensor unit. Two variables are measured: magnitude SNR and phase SNR. In general, the magnitude SNR decreases with the distance between the pipe surface and the excitation unit, while the phase SNR increases. Therefore, in some embodiments, it can be advantageous to base the measurements on the change in signal magnitude when the excitation unit 15 is relatively close to the pipe 1, and on the change in signal phase when the excitation unit 15 is relatively distant from the pipe 1.

Many embodiments of the technology described above may take the form of computer- or controller-executable instructions, including routines executed by a programmable computer or controller. Those skilled in the relevant art will appreciate that the technology can be practiced on computer/controller systems other than those shown and described above. The technology can be embodied in a special-purpose computer, controller or data processor that is specifically programmed, configured or constructed to perform one or more of the computer-executable instructions described above. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a CRT display or LCD.

From the foregoing, it will be appreciated that specific embodiments of the technology have been described herein for purposes of illustration, but that various modifications may be made without deviating from the disclosure. Moreover, while various advantages and features associated with certain embodiments have been described above in the context of those embodiments, other embodiments may also exhibit such advantages and/or features, and not all embodiments need necessarily exhibit such advantages and/or features to fall within the scope of the technology. Accordingly, the disclosure can encompass other embodiments not expressly shown or described herein.

1. An apparatus for detecting corrosion in an object, comprising:
an electrically conductive excitation unit disposed around the object;
a source of electrical power connected with the excitation unit, wherein the source of electrical power is configured to cause an alternating current in the excitation unit;
a carrier configured to carry the excitation unit; and
a magnetic sensor unit carried by the carrier or by the excitation unit, wherein the sensor is configured to detect changes in a magnetic flux.

2. The apparatus of claim 1, wherein the magnetic sensor unit is carried by a side of the carrier that is facing the object.

3. The apparatus of claim 1, wherein the object has a cylindrical shape, the object comprising:
a pipe having a corrosion patch; and
an insulation around the pipe.

4. The apparatus of claim 3, further comprising a weather shield around the insulation.

5. The apparatus of claim 4, wherein the weather shield comprises electrically conductive material.

6. The apparatus of claim 3, wherein the pipe includes a corrosion patch that is a surface defect on the outer surface of the pipe.

7. The apparatus of claim 1, wherein the source of electrical power is a transformer coil in electromagnetic (EM) communication with the excitation unit.

8. The apparatus of claim 7, further comprising a signal source connected with the transformer coil, wherein the signal source is a power amplifier.

9. The apparatus of claim 1, wherein the source of electrical current is connected to the excitation unit with cables.

10. The apparatus of claim 3, further comprising a controller configured to determine whether the object has the corrosion patch based on readings of the magnetic sensor unit.

11. The apparatus of claim 1, wherein the excitation unit is a monolithic copper conductor.

12. The apparatus of claim 1, wherein the excitation unit comprises multiple conductors, each conductor being configured to conduct the alternating current in the excitation unit.

13. The apparatus of claim 1, wherein the excitation unit is an n-sided polygon, and wherein the sides of the polygon are connected with fasteners.

14. The apparatus of claim 1, wherein the sensor unit comprises:
a radial magnetic sensor configured to sense magnetic flux in a radial direction;
an axial magnetic sensor configured to sense magnetic flux in an axial direction; and
a phi magnetic sensor configured to sense magnetic flux in a polar direction.

15. The apparatus of claim 14, further comprising a flux diverter associated with the sensor unit, wherein the flux diverted includes two flux diverter components located at opposing sides of the sensor unit, and wherein the flux diverter components are configured to divert the magnetic flux approaching the sensor unit.

16. The apparatus of claim 1, wherein the sensor unit is a first sensor unit belonging to a first sensor array configured between the excitation unit and the object, the apparatus further comprising a second sensor array axially offset from the first sensor array.

17. The apparatus of claim 14, wherein the sensor units in the first sensor array are spaced less than 10 degrees apart in a polar direction at least partially around the circumference of the pipe.

18. The apparatus of claim 12, wherein the carrier is a part of a plurality of carriers, and wherein the carriers are dielectric.

19. The apparatus of claim 18, wherein at least one carrier comprises a wheel or a slider to facilitate traversing the apparatus along the object.

20. The apparatus of claim 1, further comprising a flux concentrator disposed around the electrically conductive object.

21. A method for detecting corrosion in an object, comprising:
generating an alternating current in an electrically conductive excitation unit disposed around the object; and
detecting changes in a magnetic flux by a magnetic sensor unit that is carried by a carrier or by the excitation unit, wherein the changes in magnetic flux are caused by a corrosion patch on the object.

22. The method of claim 21, further comprising:
traversing the excitation unit axially along the object in a first direction;
rotating the excitation unit in a polar direction about the object; and
traversing the excitation unit axially along the object in a second direction opposite from the first direction.

23. The method of claim 21, wherein the carrier is dielectric.

24. The method of claim 21, wherein the alternating current is generated by a transformer coil.

25. The method of claim 24, wherein the transformer coil is connected to a power amplifier that is configured as a signal source.

26. The method of claim 21, wherein the magnetic sensor unit is configured to detect a phase of the magnetic flux.

27. The method of claim 21, further comprising shielding the magnetic sensor by flux diverter components located at opposing sides of the sensor unit.

28. The method of claim 21, wherein the sensor unit comprises:
a radial magnetic sensor configured to sense magnetic flux in a radial direction;
an axial magnetic sensor configured to sense magnetic flux in an axial direction; and
a phi magnetic sensor configured to sense magnetic flux in a polar direction.

29. The method of claim 21, wherein the sensor unit is a first sensor unit belonging to a first sensor array configured between the excitation unit and the object, the apparatus further comprising a second sensor array axially offset from the first sensor array.

30. The method of claim 29, wherein the corrosion patch is detected based on readings from the first sensor array and the second sensor array.

31. The apparatus of claim 21, wherein the excitation unit is configured to generate an alternating current at at least two frequencies.
